(19) United States
(12) Patent Application Publication
(10) Pub. No.: US 2005/0040755 A1
(43) Pub. Date: Feb. 24, 2005

(54) Transparent thin film electrode for light emitting diode and laser diode

(75) Inventors: June-o Song, Gwangju-si (KR); Dong-seok Leem, Gwangju-si (KR); Tae-yeon Seong, Gwangju-si (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/923,036

(22) Filed: Aug. 23, 2004

(30) Foreign Application Priority Data
Aug. 23, 2003 (KR) 2003-58529

(51) Int. Cl. H01J 1/62

(52) U.S. Cl. 313/503

(57) ABSTRACT

Provided is a transparent thin film electrode for forming an ohmic contact to a p-type semiconductor containing nitrogen (N) and gallium (Ga) in order to realize a high quality light emitting diode (LED) and a laser diode (LD). T he transparent thin film electrode includes a copper (Cu)-based conductive layer including Cu and another metal and a metal capping layer formed on the copper-based conductive layer. Alternatively, the transparent thin film electrode may include a Cu-based conductive layer, an intermediate layer formed on the Cu-based conductive layer, and a metal capping layer formed on the intermediate layer.

### BACKGROUND OF THE INVENTION

This application claims the priority of Korean Patent Application No. 2003-58529, filed on Aug. 23, 2003, in the Korean Intellectual Property Office, the disclosure of which is incorporated herein in its entirety by reference.

1. Field of the Invention

The present invention relates to a thin film electrode for a light emitting device, and more particularly, to a transparent thin film electrode for a light emitting diode (LED) or a laser diode (LD), which is formed on the surface of a p-type semiconductor containing at least nitrogen (N) and gallium (Ga).

2. Description of the Related Art

The formation of a high quality ohmic contact between a semiconductor and an electrode is a critical issue in realizing optical devices such as gallium nitride (GaN)-based semiconductor light emitting diodes (LEDs) and laser diodes (LDs).

A nickel (Ni)-based metallic thin film structure, i.e., Ni/Au metallic thin film, has been widely used as an ohmic contact metal film structure on a p-type GaN. It has been reported that the Ni-based metallic thin film is annealed in an oxygen (O₂) ambient to form an ohmic contact having a specific contact resistance of about 10⁻⁴ to 10⁻³ Ωcm². Due to its low specific contact resistance, heat treatment at temperature of 500 to 600° C. under an 02 ambient leads to formation of a nickel oxide (NiO) that is a p-type semiconductor oxide at a GaN/Ni interface in an island shape. Thus, holes that are majority carriers are flowed into the surface of GaN, thereby increasing effective carrier concentration near the surface of GaN.

Meanwhile, annealing of Ni/Au after contacting a p-type GaN results in disassociation of Mg—H. Through a reactivation process by which Mg concentration increases, effective carrier concentration increases above 10¹⁹ on the surface of GaN. As a result, tunneling conductance between GaN and electrode metal is raised, thereby obtaining ohmic conductance characteristics.

However, a conventional N i/Au transparent thin film electrode degrades the reliability of optical devices because of its low thermal stability and light transmissivity and high specific contact resistance. Accordingly, the conventional Ni/Au film is difficult to be used in flip-chip LEDs required for a light emitting device offering large capacity and high brightness and LDs requiring lower ohmic contact resistance.

### SUMMARY OF THE INVENTION

The present invention provides a transparent film electrode for making an ohmic contact on the surface of a p-type semiconductor containing at least nitrogen (N) and gallium (Ga), the transparent film electrode offering high device yields due to a smooth surface morphology and a good connection with the external when mounting a device, reduced electric loss due to excellent electrical characteristics such as low resistance and good current-voltage (I-V) characteristics, and outstanding optical characteristics as compared to a conventional transparent film electrode.

According to an aspect of the present invention, there is provided a transparent thin film electrode for a p-type semiconductor light emitting device containing at least nitrogen (N) and gallium (Ga). The transparent thin film electrode includes a copper (Cu)-based conductive layer comprising Cu and another metal and a metal capping layer formed on the Cu-based conductive layer.

Alternatively, a transparent thin film electrode for a p-type semiconductor light emitting device containing at least nitrogen (N) and gallium (Ga) may include a Cu-based conductive layer comprising Cu and another metal, an intermediate layer formed on the Cu-based conductive layer, and a metal capping layer formed on the intermediate layer.

The Cu-based conductive layer is a Cu-based alloy or solid solution layer (hereinafter called the “Cu-based alloy layer”).

The p-type semiconductor refers to one containing two or more elements including Ga and N. For example, the p-type semiconductor may be a p-type GaN, a p-type AlₓIn_{y}Ga_{z}N (0<x+y+z<1), a p-type AlₓGa₁₋ₓN, or a p-type In_{y}Ga_{1-y}N.

The Cu-based conductive layer may be made of any metal that can serve as a dopant of Cu₂O that is a p-type semiconductor during annealing in an O₂ ambient, thereby improving the electrical characteristics. T he another metal is at least one of Ni, Co, Pd, Pt, Ru, Rh, Ir, Ta, Cr, Mn, Mo, Tc, W, Re, Fe, Sc, Ti, Sn, Ge, Sb, Ag, Al, lanthanide (Ln) (for example, La), and Zn.

The metal capping layer may be made of any metal that exhibits oxidation stability, good wire bonding, and excellent transparency and can prevent surface degradation during a high temperature process. T he metal is at least one selected among Au, Ni, Co, Cu, Pd, Pt, Ru, Rh, Ir, Ta, Cr, Mn, Mo, Tc, W, Re, Fe, Sc, Ti, Sn, Ge, Sb, Ag, Al, Ln, and Zn.

The intermediate layer may be made of a metal having a high work function value, which is advantageous for forming an ohmic contact to the p-type GaN, and capable of forming a Ga-based compound during heat treatment.

The metal contained in the intermediate layer is at least one selected among Ni, Co, Cu, Pd, Pt, Ru, Rh, Ir, Ta, Cr, Mn, Mo, Tc, W, Re, Fe, Sc, Ti, Sn, Ge, Sb, Ag, Al, Ln, and Zn.

The content of a solute metal added to the Cu in the Cu-based conductive layer may be 0.1 to 49 atom %. The thicknesses of the Cu-based conductive layer, the metal capping layer and the intermediate layer may be 0.1 to 1,000 nm, respectively.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the structure of a transparent film electrode including a Cu-based alloy or solid solution layer and a capping layer made of metal such as gold (Au) sequentially deposited according to a first embodiment of the present invention;

FIG. 2 illustrates the structure of a transparent film electrode including a Cu-based alloy or solid solution layer, an intermediate layer made of metal such as nickel (Ni), and a capping layer made of metal such as Au sequentially deposited according to a second embodiment of the present invention;

FIG. 3 illustrates the results of electrical measurements measured from a resultant structure deposited on a p-type GaN before and after performing annealing the resultant structure in a ir and nitrogen (N₂) ambients after depositing a copper (Cu)—Ni alloy or solid solution layer and an Au layer on the p-type GaN having carrier concentration of 4×10¹⁷ to 5×10¹⁷ cm³, respectively;

FIG. 4 illustrates current-voltage (I-V) characteristics measured from a resultant structure deposited on a p-type GaN before and after performing annealing the resultant structure in air and N₂ ambients after depositing a Cu—Ni alloy or solid solution layer and an Ag layer on the p-type GaN having carrier concentration of 4×10¹⁷ to 5×10¹⁷ cm⁻³, respectively;

FIG. 5 illustrates I-V characteristics of the resultant structure obtained by performing annealing in an air ambient after depositing a Cu—Ni alloy or solid solution layer and an Au layer as p-type electrode materials of a Blue Indium Gallium Nitride (InGaN) LED; and

FIG. 6 illustrates I-V characteristics of the resultant structure obtained by performing annealing in an air ambient after depositing a Cu-Ni alloy or solid solution layer and an Ag layer as p-type electrode materials of a Blue InGaN LED.

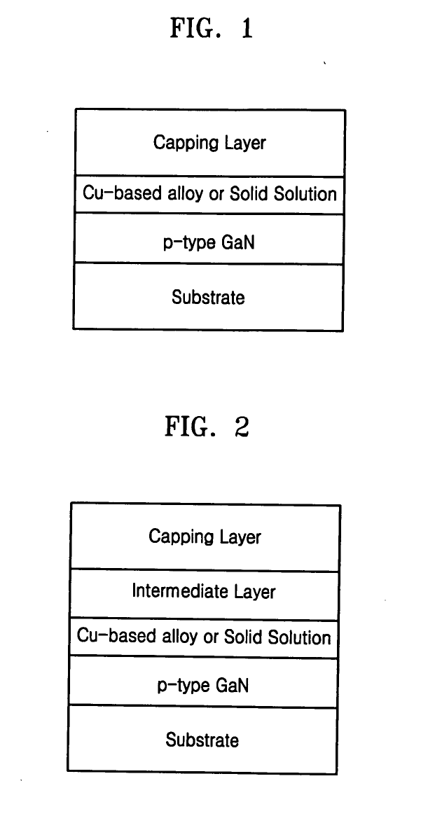

### DETAILED DESCRIPTION OF THE INVENTION

Transparent film electrodes for high quality light emitting diodes (LEDs) and laser diode (LDs) according to embodiments of the present invention will now be described in detail. In the drawings, the thicknesses of layers and regions are exaggerated for clarity.

To obtain a high quality ohmic contact to a p-type gallium nitride (GaN), it is perferable that the concentration of carriers are above 1×10¹⁷ cm⁻³. Also, it is perferable that a metal that is more reactive with Ga than with nitrogen in a p-type GaN semiconductor is used. The reaction between GaN and a metal in a p-type GaN semiconductor creates a Ga vacancy on the surface of the GaN semiconductor, which acts as a p-type dopant. Thus, the reaction between GaN and a metal in a p-type GaN semiconductor increases the effective p-type carrier concentration on the GaN surface. Furthermore, to decrease Schottky barrier height (SBH), a metal that can reduce native gallium oxide (Ga₂O₃) is required. The native oxide residing on the surface of the p-type GaN impedes the flow of carriers at an interface between an electrode material and GaN. During creation of the Ga vacancy and reduction of the native oxide on the surface of the surface of the p-type GaN, tunneling conductance may occur at the interface between the GaN semiconductor and metal electrode contacting it.

A Cu-based alloy layer used in the present invention acts as both a reducing agent of the native oxide due to its excellent oxidation power and a dopant in the p-type GaN that causes the hole concentration to increase near the GaN surface. Furthermore, since copper oxide (Cu₂O) produced by annealing in an oxygen (O₂) ambient and a solute metal added to the Cu-based alloy layer have a work function value equal to that of GaN. Thus, when the Cu-based alloy layer is in contact with the p-type GaN, the SBH decreases, thus improving ohmic contact characteristics of a transparent thin film electrode. The solute metal added to the Cu-based alloy is at least one of nickel (Ni), cobalt (Co), palladium (Pd), platinum (Pt), ruthenium (Ru), rhodium (Rh), iridium (Ir), tantalum (Ta), chromium (Cr), manganese (Mn), molybdenum (Mo), technetium (Tc), tungsten (W), rhenium (Re), iron (Fe), scandium (Sc), titanium (Ti), stannum (Sn), germanium (Ge), stibium (Sb), silver (Ag), aluminum (Al), lanthanide (Ln), for example, La, and zinc (Zn). T he solute metal serves as a dopant of Cu₂O that is a p-type semiconductor during annealing in an O₂ ambient, thereby improving the electrical characteristics. In this case, the content of the solute metal to be added is not limited to a specific value, but it may be preferably around 0.1 to 49 atom %.

The Cu-based alloy or solid solution layer is formed by fabricating a Cu-based alloy and then depositing the Cu-based alloy over the p-type GaN and the LED using an electron-beam evaporator. In this case, the p-type GaN and the LED may be patterned through a photolithography technique and have ohmic patterns.

Meanwhile, during a high temperature process (300 to 600° C.) commonly applied to fabrication of LED or LD, surface degradation occurs. A material used as the uppermost layer (capping layer) of the transparent film electrode is preferably a metal exhibiting stability against oxidation and surface degradation, good wire bonding, and excellent transparency. A representative example of this metal is Au or Ag. In addition, this metal may be at least one of Ni, Co, Cu, Pd, Pt, Ru, Rh, Ir, Ta, Cr, Mn, Mo, Tc, W, Re, Fe, Sc, Ti, Sn, Ge, Sb, Ag, Al, Ln, and Zn.

In particular, an intermediate layer is preferably made of metals having a high work function value, which is advantageous for forming an ohmic contact to the p-type GaN, and capable of forming a Ga-based compound during heat treatment. For example, the metals may be at least one of Ni, Co, Cu, Pd, Pt, Ru, Rh, Ir, Ta, Cr, Mn, Mo, Tc, W, Re, Fe, Sc, Ti, Sn, Ge, Sb, Al, Ln, and Zn.

A transparent thin film electrode according to the present invention may b e deposited using an E-beam evaporator, physical vapor deposition (PVD), chemical vapor deposition (CVD), plasma laser deposition (PLD), a dual-type thermal evaporator, or an evaporator where sputtering can be used. Although there is no specific limitation on deposition conditions, it is desirable that the deposition temperature is 20 to 1,500° C. and the pressure ranges from atmospheric pressure to about 10⁻¹² Torr.

To further improve ohmic characteristics, the transparent film electrode is preferably annealed at a temperature below 700° C. for 1 second to 10 hours under vacuum or in nitrogen (N₂), argon (Ar), helium (He), O₂, hydrogen (H₂), air or mixed gas ambient

Ohmic characteristics of a transparent film electrode according to an embodiment of the present invention will now be described in detail.

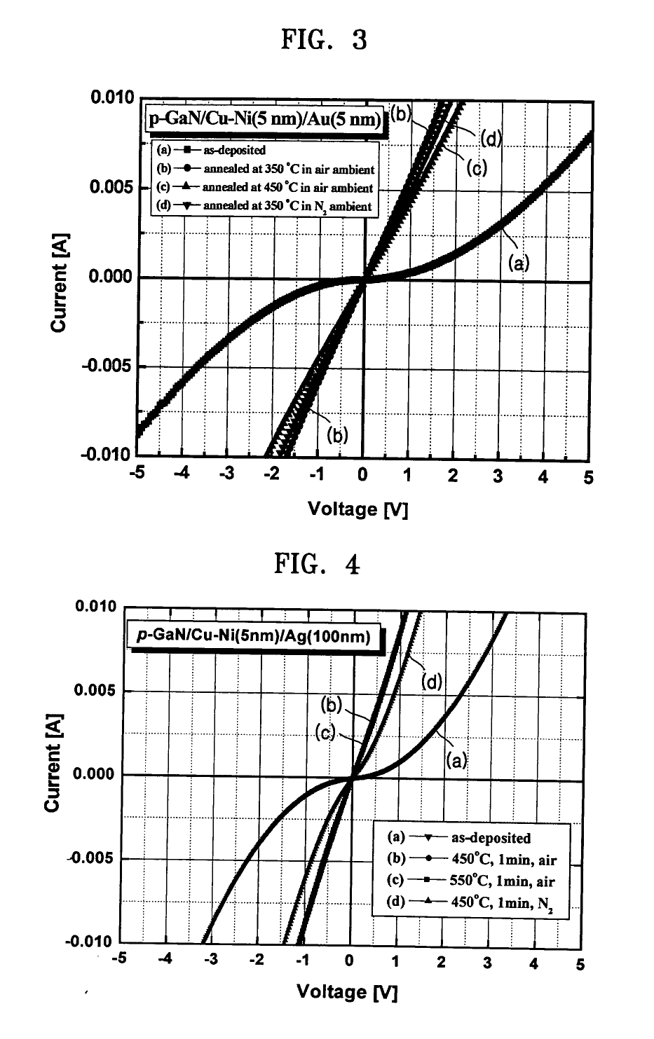

FIG. 3 shows the electrical characteristics measured on the resultant structures obtained by performing annealing in an air ambient after depositing a Cu-Ni alloy layer and an Au layer on a p-type GaN substrate having carrier concentration of 4×10¹⁷ to 5×10¹⁷ cm⁻³, respectively. (a) in FIG. 3 represents nonlinear I-V characteristics of an as-deposited ohmic contact showing a rectifying behavior, and (b), (c), and (d) represent linear I-V characteristics showing ohmic contact characteristics for a resultant structure, which are obtained by performing annealing at 350° C. for 1 minute in an air ambient, at 450° C. for 1 minute in an air ambient, and at 350° C. for 1 minute in an N₂ ambient after metal deposition, respectively. As is evident by FIG. 3, specific contact resistance obtained is as low as 10⁻⁶ to 10⁻⁵ Ωcm².

FIG. 4 shows the electrical characteristics measured on the resultant structures obtained by performing annealing at 350 to 550° C. in an air ambient after depositing a Cu—Ni alloy layer and an Ag layer on a p-type GaN substrate having carrier concentration of 4×10¹⁷ to 5×10¹⁷ cm⁻³, respectively. (a) in FIG. 4 represents nonlinear I-V characteristics showing rectifying characteristics of a transparent thin film electrode before annealing and (b), (c), and (d) represent linear I-V characteristics containing information on the resultant ohmic contacts obtained by performing annealing at 450° C. for 1 minute in an air ambient, at 550° C. for 1 minute in an air ambient, and at 450° C. for 1 minute in an N₂ ambient after metal deposition, respectively. As is evident by FIG. 4, specific contact resistance obtained is as low as 10⁻⁶ to 10⁻⁵ Ωcm².

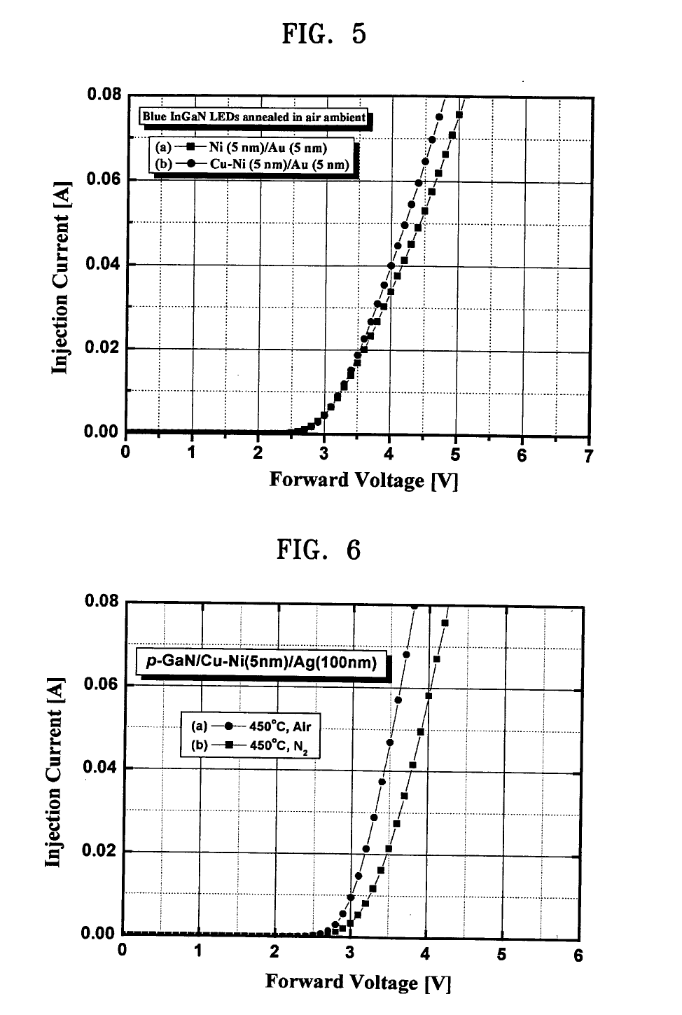

FIG. 5 illustrates I-V characteristics of the resultant structure obtained by performing annealing in an air ambient after depositing a Cu—Ni alloy layer and an Au layer as p-type electrode materials of a Blue Indium Gallium Nitride (InGaN) LED. (a) in FIG. 5 represents I-V characteristics of the resultant structure obtained by performing annealing at 550° C. for 1 minute in an air ambient after deposition of Ni/Au, and as is evident from (a), current is 20 mA at operating voltage of 3.61 V. (b) represents I-V characteristics of the resultant structure obtained by performing annealing at 450° C. for 1 minute in an air ambient after deposition of Cu—Ni/Au, and as is evident by (b), current is 20 mA at operating voltage of 3.52 V.

The Cu-Ni/Au structure of the present invention has an operating voltage that is 0.1 V lower than that of a conventional Ni/Au structure, which means that an ohmic contact with the Cu-Ni/Au structure is better than that with the Ni/Au structure. Accordingly, an LED employing the ohmic contact structure according to the present invention has low series resistance.

FIG. 6 illustrates I-V characteristics of the resultant structure obtained by performing annealing in an air ambient after depositing a Cu—Ni alloy layer and an Ag layer as p-type electrode materials of a Blue InGaN LED. (a) in FIG. 6 represents I-V characteristics of the resultant structure obtained by performing annealing at 450° C. for 1 minute in an air ambient after deposition of the Cu—Ni alloy layer/Ag layer, and as is evident by (a), current is about 20 mA at operating voltage of 3.21 V. (b) represents I-V characteristics of the resultant structure obtained by performing annealing at 450° C. for 1 minute in an N₂ ambient after deposition of Cu—Ni/Ag, and as is evident from (b), current is about 20 mA at operating voltage of 3.47 V.

As demonstrated in FIG. 6, when the Cu—Ni/Ag structure is annealed in air containing O₂ instead of N₂ ambient, the Cu—Ni/Ag structure has a 3.2 V operating voltage at 20 mA current, which is lower than 3.4 V, a typical operating voltage of a GaN-based LED. This means that a good ohmic contact can be achieved through the Cu—Ni/Ag structure. Accordingly, the series resistance of LED can be reduced.

Preferred embodiments of the present invention will now be described in more detail. These embodiments should be considered in descriptive sense only and not for purposes of limitation.

<First Embodiment>

The fabrication of a transparent thin film electrode according to a first embodiment of the present invention started with cleaning the surface of a p-type GaN substrate in a ultrasonic bath with trichloro ethylene, acetone, methanol, and distilled water for 5 minutes each at temperature of 60° C. A hard bake was then performed for 10 minutes at 100° C. to remove water from the p-type GaN substrate. A photosensitive layer was applied over he p-type GaN substrate at 4,500 rpm, followed by soft bake on the p-type GaN substrate over which the photosensitive layer has been applied for 15 minutes at 60° C. Subsequently, a mask was aligned relative to the p-type GaN substrate onto which a ultraviolet (UV) ray of 22.8 mW was then emitted for 15 seconds. The resultant structure was then developed within a developer diluted 1:4 with distilled water for 25 minutes, followed by 5 minutes of immersion in a BOE water, which allows a contamination layer to be removed from the resultant structure obtained after developing. Next, a Cu—Ni alloy layer (5 nm) and an Au layer (5 nm) were sequentially deposited on the resultant structure from which the contamination layer has been removed using an electron-beam evaporator. A lift-off was performed by immersing in acetone and then the p-type GaN substrate was annealed for 1 minute in a rapid thermal annealer (RTA) in an air ambient at 550° C. to form an ohmic contacted transparent thin film electrode, thereby completing fabrication of the transparent thin film electrode according to the first embodiment of the present invention.

<Second Embodiment>

The step of removing a contamination layer from the developed p-type GaN substrate is the same as for the first embodiment. Then, a Cu—Ni alloy layer (5 nm) and an Ag layer (100 nm) were sequentially deposited on the resultant structure from which the contamination layer has been removed using an electron-beam evaporator. A lift-off was performed by immersing in acetone and then the p-type GaN substrate was annealed for 1 minute in a RTA in an air ambient at 350 to 550° C. to form an ohmic contact, thereby completing fabrication of a transparent film electrode according to the second embodiment of the present invention.

As is evident from RMS surface roughness value measured by an atomic force microscopy (AFM), a transparent film electrode according to the present invention exhibits a smooth surface morphology.

Thus, the transparent film electrode of the present invention allows a good connection with the external when mounting a device, thereby increasing device yields. Furthermore, the present invention provides excellent electrical characteristics such as low resistance and good I-V characteristics, thereby reducing electric loss, as well as outstanding optical characteristics. Accordingly, the transparent film electrode is very advantageous in realizing high equality flip-chip LEDs having higher luminous efficiency than those of typical top-emitting LEDs.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A transparent thin film electrode for a p-type semiconductor light emitting device which contains at least nitrogen (N) and gallium (Ga), the transparent thin film electrode comprising:
a copper (Cu)-based conductive layer comprising Cu and another metal; and
a metal capping layer formed on the Cu-based conductive layer.

2. The electrode of claim 1, wherein the Cu-based conductive layer is one of a Cu-based alloy layer and a Cu-based solid solution layer.

3. The electrode of claim 1, wherein the another metal is at least one selected from the group consisting of nickel (Ni), cobalt (Co), palladium (Pd), platinum (Pt), ruthenium (Ru), rhodium (Rh), iridium (Ir), tantalum (Ta), chromium (Cr), manganese (Mn), molybdenum (Mo), technetium (Tc), tungsten (W), rhenium (Re), iron (Fe), scandium (Sc), titanium (Ti), stannum (Sn), germanium (Ge), stibium (Sb), silver (Ag), aluminum (Al), lanthanide (Ln), and zinc (Zn).

4. The electrode of claim 1, wherein a metal contained in the metal capping layer is at least one selected from the group consisting of Au, Ni, Co, Cu, Pd, Pt, Ru, Rh, Ir, Ta, Cr, Mn, Mo, Tc, W, Re, Fe, Sc, Ti, Sn, Ge, Sb, Ag, Al, lanthanide (Ln), and Zn.

5. The electrode of claim 1, wherein the content of a solute metal added to the Cu in the Cu-based conductive layer is 0.1 to 49 atom %.

6. The electrode of claim 1, wherein the thicknesses of the Cu-based conductive layer and the metal capping layer are 0.1 to 1,000 nm, respectively.

7. The electrode of claim 1, wherein the p-type semiconductor is a p-type GaN or a p-type AlₓIn_{y}Ga_{z}N (0<x+y+z≦1).

8. A transparent thin film electrode for a p-type semiconductor light emitting device which contains at least nitrogen (N) and gallium (Ga), the transparent thin film electrode comprising:
a copper (Cu)-based conductive layer including Cu and another metal;
an intermediate layer formed on the Cu-based conductive layer; and
a metal capping layer formed on the intermediate layer.

9. The electrode of claim 8, wherein the Cu-based conductive layer is one of a Cu-based alloy layer and a Cu-based solid solution layer.

10. The electrode of claim 8, wherein a metal contained in the intermediate layer is at least one selected from the group consisting of nickel (Ni), cobalt (Co), Cu, palladium (Pd), platinum (Pt), ruthenium (Ru), rhodium (Rh), iridium (Ir), tantalum (Ta), chromium (Cr), manganese (Mn), molybdenum (Mo), technetium (Tc), tungsten (W), rhenium (Re), iron (Fe), scandium (Sc), titanium (Ti), stannum (Sn), germanium (Ge), stibium (Sb), silver (Ag), aluminum (Al), lanthanide (Ln), and zinc (Zn).

11. The electrode of claim 8, wherein the another metal is at least one selected from the group consisting of Ni, Co, Pd, Pt, Ru, Rh, Ir, Ta, Cr, Mn, Mo, Tc, W, Re, Fe, Sc, Ti, Sn, Ge, Sb, Ag, Al, lanthanide (Ln), and Zn.

12. The electrode of claim 8, wherein a metal contained in the metal capping layer is at least one selected from the group consisting of Au, Ni, Co, Cu, Pd, Pt, Ru, Rh, Ir, Ta, Cr, Mn, Mo, Tc, W, Re, Fe, Sc, Ti, Sn, Ge, Sb, Ag, Al, lanthanide, and Zn.

13. The electrode of claim 8, wherein the content of a solute metal added to the Cu in the Cu-based conductive layer is 0.1 to 49 atom %.

14. The electrode of claim 8, wherein the thicknesses of the Cu-based conductive layer, the metal capping layer and the intermediate layer are 0.1 to 1,000 nm, respectively.

15. The electrode of claim 8, wherein the p-type semiconductor is a p-type GaN or a p-type AlₓIn_{y}Ga_{z}N (0<x+y+z≦1).
